(19) United States
(12) Patent Application Publication
(10) Pub. No.: US 2026/0191729 A1
(43) Pub. Date: Jul. 9, 2026

(54) LOWER LIMB EXOSKELETON

(71) Applicant: INMUEBLES MOLÍ, SL, Martorelles (ES)

(72) Inventor: Joan SINGLA CASASAYAS, Martorelles (ES)

(73) Assignee: INMUEBLES MOLÍ, SL, Martorelles (ES)

(21) Appl. No.: 19/351,610

(22) Filed: Oct. 7, 2025

(30) Foreign Application Priority Data
Dec. 17, 2024 (EP) 24383388.6

(51) Int. Cl. A61H 3/00; A61H 1/02

(52) U.S. Cl. CPC A61H 3/00; A61H 1/0262; A61H 2003/007; A61H 2201/0107; A61H 2201/123; A61H 2201/1621; A61H 2201/1635; A61H 2201/1642; A61H 2230/625

(57) ABSTRACT

Lower limb exoskeleton comprising a torso module (20), including an adjustable abdominal binder (22), and two lower limb assemblies (10) connected to the torso module (20) through a hip joint (21), each limb assembly (10) comprising, an upper leg module (11), a knee joint (12), a lower leg module (13) and a lower supporting foothold (15), each limb assembly (10) further comprising a knee actuation mechanism (40) including a pushrod (42), slidably connected to the lower leg module, with a lower end (42b) protruding downwardly below the lower supporting foothold (15) when the pushrod (42) is not in the uppermost position, and an upper end (42a) connected to the upper leg module (11) via a kinematic linkage configured to push the upper leg module (11) into an extended position when the pushrod (42) is moved upwards by resting the lower end (42b) thereof against a ground under user's body weight.

### TECHNICAL FIELD

The present invention is directed to a lower limb exoskeleton intended to provide assistance for a patient or an injured person who cannot walk normally or someone who must carry a heavy load in a particular situation or stay in upright position for extended periods of time.

### BACKGROUND OF THE INVENTION

Lower limb exoskeletons are known in the state of the art, for example through documents EP2326288B1, EP3313350B1 or EP3538030B1.

Those documents describe different solutions, some of which are motorized, that provide walking assistance for people with mobility difficulties.

However, the solutions proposed in those documents do not provide a system that prevents unintentional bending of the knee when weight is placed on the leg by means of a simple, reliable and low-cost mechanical solution.

They also do not offer a solution to the problem of how to attach the exoskeleton to the user's body in a comfortable and safe way during long hours of use, allowing the transfer of most of the user's weight to the exoskeleton without having to resort to the use of a harness with bands located in the groin region, where the pressure of these bands could put pressure on veins and arteries, increasing the risk of suffering a vascular accident, such as a thrombus.

The present invention provides solutions to these and other problems.

### DESCRIPTION OF THE INVENTION

The present invention relates to a lower limb exoskeleton, as defined in claim 1, which is intended to support most of the weight of the body of the lower limb exoskeleton user by transferring said weight to the ground through the lower limb exoskeleton, thereby ensuring that the user does not have to support all of said weight with his/her own legs, which may not be able to support said weight due to age, disease or injury, or simply to reduce fatigue or to avoid injuries.

The proposed lower limb exoskeleton comprises:
a torso module including an adjustable abdominal binder and two lower limb assemblies connected to the torso module through a hip joint, each limb assembly comprising, connected in succession, an upper leg module, a knee joint, a lower leg module and a lower supporting foothold, wherein the hip joint and the knee joint are articulated joints;
each limb assembly further comprises a knee actuation mechanism configured to modify the angle of the knee joint when actuated;
at least the upper leg module and the lower leg module including at least one body attachment configuration intended for attachment to an adjacent body part of a user.

The torso module is a module intended to be attached around a torso of a user through the mentioned adjustable abdominal binder. The adjustable abdominal binder typically comprises a textile band with a hook and loop fastener (Velcro or similar).

Each lower limb assembly comprises an upper leg module and a lower leg module connected in an articulated manner through a knee joint, allowing the movement of said upper and lower leg modules between an extended position, in which both upper and lower leg modules are approximately parallel or aligned, typically forming an angle comprised between 170° and 180°, and a flexed position in which both upper and lower leg modules form an angle lower than 170°, typically comprised between 170° and 90°.

The knee joint is articulated around a single transverse axis, approximately horizontal and perpendicular to a sagittal plane.

Each lower limb assembly is connected to the torso module though a hip joint, which is articulated at least around a transverse axis, approximately horizontal and perpendicular to a sagittal plane, and preferably also including one or two additional degrees of freedom, for example by including a ball joint in the hip joint or by including one hinge, articulated around an axis perpendicular to the upper leg module, between the hip joint and at least a portion of the upper leg module.

All positions and orientations, such as front, rear, up, down, vertical, horizontal, transverse, or other geometric references such as sagittal plane, etc., are understood to be referenced with respect to a hypothetical user wearing the lower limb exoskeleton in an upright position, being those orientations of the lower limb exoskeleton coincident with the orientations referred to said user. According to this proposed coordinate system, the front axis is a horizontal axis passing from the front side to the back side of the user and the transverse axis is a horizontal axis, perpendicular to the front axis, passing from one lateral side to the opposed lateral side of the user. Also, it will be understood that positions, such as parallel, perpendicular, tangent, etc. allow deviations up to ±5° from the theoretical position defined by this nomenclature.

The lower supporting foothold is in the lowermost end of the lower limb assembly and is intended to be supported on a floor to transfer vertical loads thereto, reducing the load on the user's leg.

The present invention also proposes the following:
the knee actuation mechanism comprises a pushrod with an intermediate region slidably connected to the lower leg module for a guided linear movement of the pushrod along a linear displacement path, the pushrod including a lower end protruding downwardly below the lower supporting foothold when the pushrod is not in the uppermost position of the linear displacement path, and including an upper end connected to the upper leg module via a kinematic linkage configured to push the upper leg module into an extended position when the pushrod is moved upwards by resting the lower end thereof against a ground under user's body weight.

To prevent an uncontrolled bend of the knee joint under the weight transferred trough the lower limb assembly, preventing the transfer of weight, said knee joint includes a knee actuation mechanism.

The knee actuation mechanism comprises a pushrod which is typically parallel to the lower leg module, and is attached in a sliding manner thereto, allowing for a sliding movement of the pushrod up and down along the lower leg module.

An upper end of the pushrod is kinematically linked to the upper leg module, said connection being configured to produce a descending movement of the pushrod when the lower limb assembly is flexed from an extended position towards a flexed position.

When the pushrod is in the uppermost position, called extension position, a lower end of the pushrod is flush with the lower supporting foothold, and when the pushrod is pushed down due to the flexion of the lower limb assembly, the lower end of the pushrod projects downwardly from the lower supporting foothold.

Thus, when the lower limb assembly somehow flexed, for example during the walking movement, the lower end of the pushrod projects downwardly and contacts with the ground before the lower supporting foothold and the weight of the user rests on said pushrod urging the pushrod upwards, producing the extension movement of the lower leg assembly, until the lower supporting foothold reaches the ground, stopping the upward movement of the pushrod.

In a similar manner, when the user flexes the knee, the pushrod is moved downwards, helping the raising of the foot from the ground.

In this manner, thanks to the knee actuation mechanism, during the walking motion of the user, when the weight is supported in a single leg, the weight supported by said leg makes impossible to bend the knee, because the pushrod cannot be moved downwards against the ground, preventing an unintended bending of said leg while all the weight is conducted through the lower leg assembly. Meanwhile, the other leg free of weight can be bent and the foot can be raised from the ground.

Preferably, the torso module comprises two sub-axilla supports, each extending upwards from one hip joint.

The sub-axilla support is a support intended to be positioned under the axilla of the user. Typically, a sub-axilla support will have an upwards facing arched-shape or a saddle-shape, to provide retention under the user's arm, and may include some cushioning.

The sub-axilla support, in conjunction with the adjustable abdominal binder, transfers a considerable portion of the user's weight to the hip joints, and to the lower limb assemblies which conduct such weight to the lower supporting foothold, freeing the user's legs from bearing such weight.

Optionally, the two sub-axilla supports can be combined with two shoulder straps, connected to the torso module to prevent an excessive raising of the shoulders when the weight is transferred through the sub-axilla supports.

Said two sub-axilla supports, located under the arms help the adjustable abdominal binder to support part of the body's weight, and at the same time, the adjustable abdominal binder includes two shoulder straps which, passing over the shoulders, fix the height of the shoulders, so that the sub-axilla supports intended to support part of the body's weight do not raise the shoulders higher than usual.

In addition, or instead, of the two shoulder strips, the two sub-axilla supports may further be combined with a sub-gluteal support extending downwards from a back side of the adjustable abdominal binder.

The sub-gluteal support is a small concave support, similar to a perch seat, intended to contain the glutes of the user, providing retention to the torso module against an upward movement.

Preferably, the sub-gluteal support is made of textile, and includes a transversal strap along its bottommost edge, said strap extending from both lateral sides of the sub-gluteal support. Said extensions of the strap can be attached to a front region of the adjustable abdominal binder to adjust the concave shape and size of the sub-gluteal support to the user.

According to the above, the transversal strap of the sub-gluteal support surrounds the user from under the glutes of the user to, or above, the belly, the lateral sides of the transversal strap having an inclination of around 40° to 50° regards the horizontal.

The adjustable abdominal binder may further include vertical reinforcement ribs, for example on its back side, preferably along the lumbar region. Those vertical reinforcement ribs provide a better distribution of the loads around the torso of the user.

Preferably, the torso module is devoid of inguinal straps connecting the back side and a front side of the adjustable abdominal binder. The inguinal region of the user is a very sensible area and contains many important arteries, veins and nerves, and the compression of such arteries, veins and/or nerves during long hours of use by inguinal straps may cause harm.

The torso module of the proposed invention can dispense with the use of inguinal straps by using the above described adjustable abdominal binder, which wraps the torso and distribute the loads, distributing the pressure to the maximum surface of the torso of the user, and optionally also using the sub-axilla supports and the sub-gluteal support, avoiding the use of inguinal straps around the upper part of the legs through the inguinal region and thus avoiding pressing the femoral veins and avoiding possible damage such as an ‘Ictus’ or infarct.

### BRIEF DESCRIPTION OF THE FIGURES

The foregoing and other advantages and features will be more fully understood from the following detailed description of an embodiment with reference to the accompanying drawings, to be taken in an illustrative and non-limitative manner, in which:

FIG. 1 shows a lateral view of the proposed lower limb exoskeleton, in extended position, according to a first embodiment wherein the lower supporting foothold is a footwear, in this case a boot, and wherein the torso module comprises two sub-axilla supports, two shoulder straps and one sub-gluteal support.

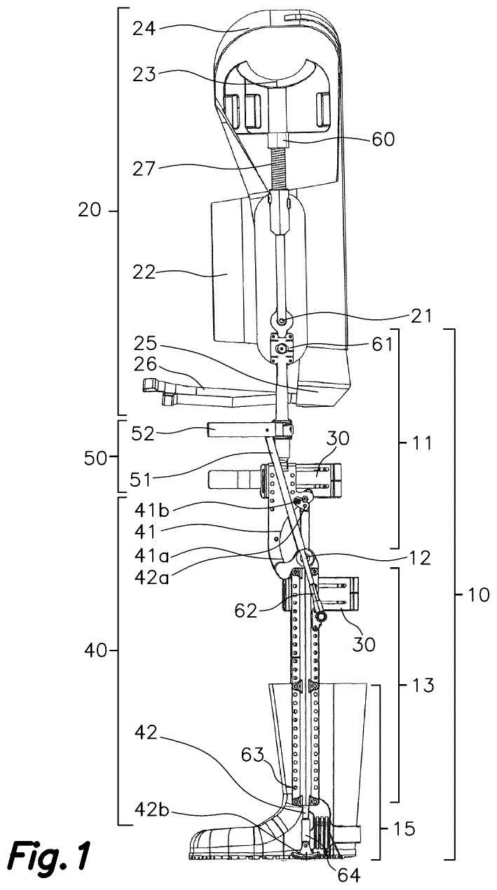

FIG. 2 shows the same lateral view but with the lower limb assembly in a flexed position.

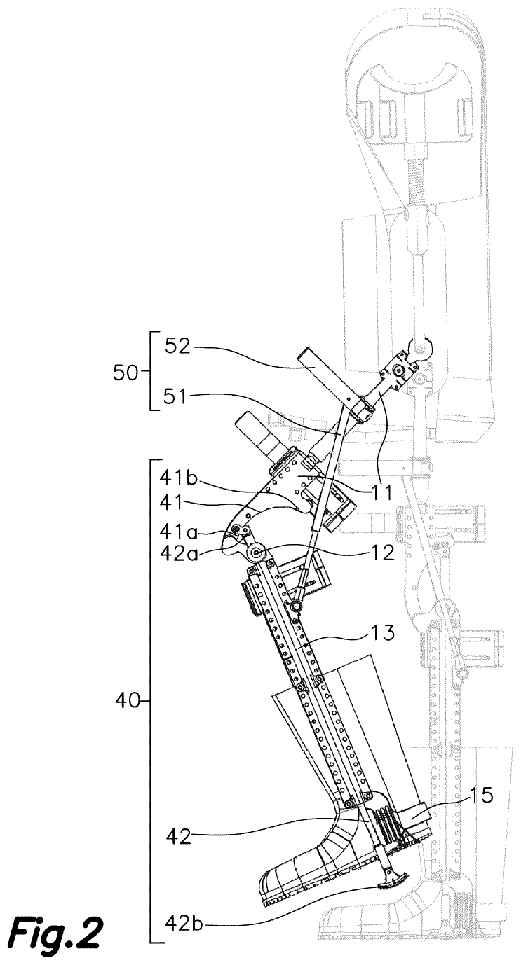

FIG. 3 shows the same lower limb exoskeleton shown in FIG. 1 but in a frontal view.

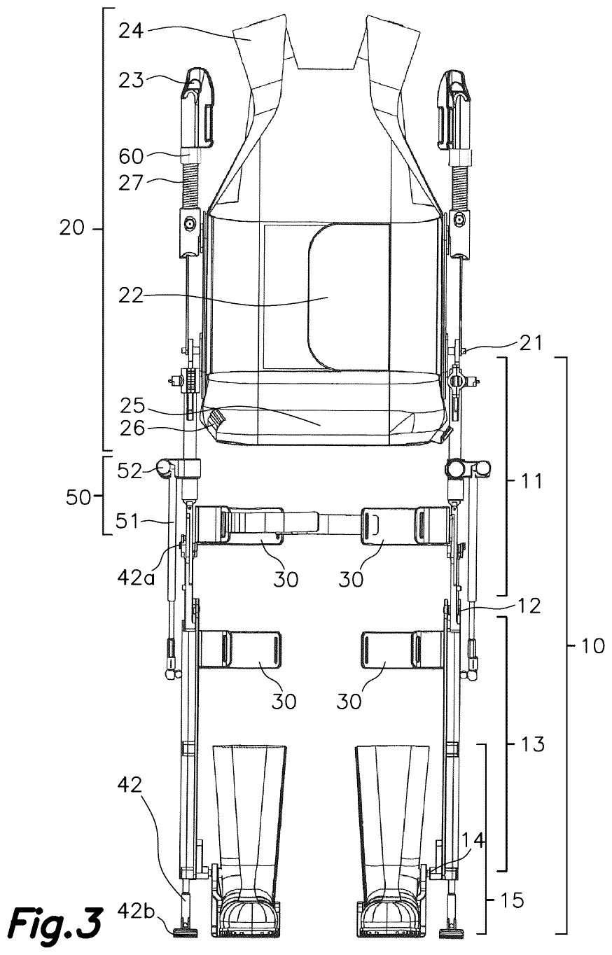

FIG. 4 shows a frontal view of the limb exoskeleton but according to an alternative embodiment in which the lower supporting foothold is a stirrup attachable to a footwear of the user.

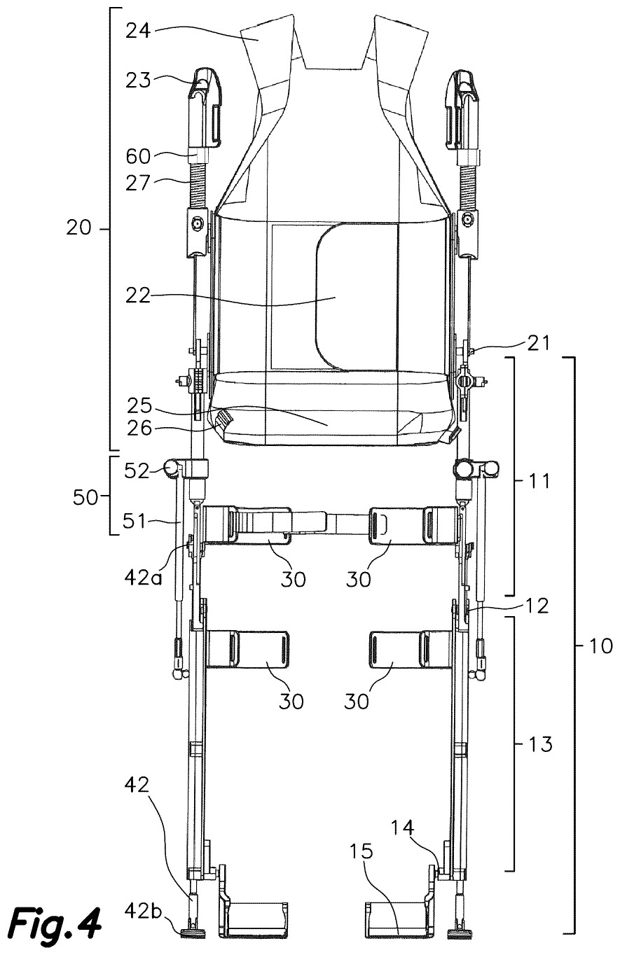

FIG. 5 shows a frontal view of the limb exoskeleton but according to an additional alternative embodiment in which the knee actuation mechanism further comprises a linear motor with one end connected to the upper leg module and the other end connected to the lower leg module.

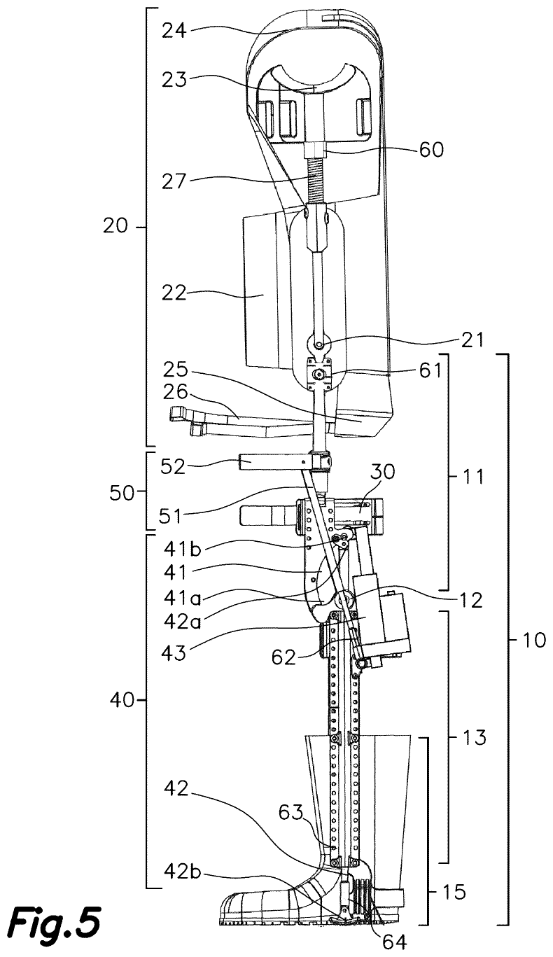

### DETAILED DESCRIPTION OF THE INVENTION AND OF PARTICULAR EMBODIMENTS

The proposed lower limb exoskeleton comprises a torso module 20, including an adjustable abdominal binder 22, and two lower limb assemblies 10 connected to the torso module 20 through a hip joint 21.

Each limb assembly 10 comprises, connected in succession, an upper leg module 11, a knee joint 12, a lower leg module 13 and a lower supporting foothold 15. The hip joint 21 and the knee joint 12 are joints articulated, at least around one transverse axis perpendicular to the sagittal plane of the user wearing the lower limb exoskeleton.

Each limb assembly 10 further comprises a knee actuation mechanism 40 configured to modify the angle of the knee joint 12 when actuated.

At least the upper leg module 11 and the lower leg module 13 includes at least one body attachment configuration 30 intended for attachment to an adjacent body part of a user, for example using a textile band with a hook and loop fastener (Velcro or similar) or other adjustable systems.

The proposed knee actuation mechanism 40 comprises a pushrod 42 with an intermediate region slidably connected to the lower leg module 13 for a guided linear movement of the pushrod 42 along a linear displacement path, the pushrod 42 including a lower end 42b protruding downwardly below the lower supporting foothold 15 when the pushrod 42 is not in the uppermost position of the linear displacement path, and including an upper end 42a connected to the upper leg module 11 via a kinematic linkage configured to push the upper leg module 11 into an extended position when the pushrod 42 is moved upwards by resting the lower end 42b thereof against a ground under user's body weight.

The torso module 20 may comprise two sub-axilla supports 23, each extending upwards from one hip joint 21, optionally combined with two shoulder straps 24 and/or with a sub-gluteal support 25 extending downwards from a back side of the adjustable abdominal binder 22.

Preferably, the sub-gluteal support 25 is made of textile, and includes a transversal strap 26 along its bottommost edge, said strap extending from both lateral sides of the sub-gluteal support 25. Said extensions of the transversal strap 26 can be attached to a front region of the adjustable abdominal binder 22 to adjust the concave shape and size of the sub-gluteal support 25 to the user.

The adjustable abdominal binder 22 may further include vertical reinforcement ribs to better distribute the loads around the user's torso.

The torso module 20 preferably lacks inguinal straps connecting a back side and a front side of the adjustable abdominal binder 22, passing through the inguinal region between the legs of the user. The inguinal straps may be harmful and avoiding its use is beneficial. The function provided by the inguinal straps may be replaced by the sub-axillar supports 23 and/or for the sub-gluteal support 25.

According to one embodiment of the invention, each sub-axilla support can be connected to the hip joint located below through a non-compressible connection, or through a flexible non-compressible connection. Optionally, the non-compressible connection is a flexible connection, for example one axially collapsed spring 27 where each loop rests on top of the preceding loop or two nested axially collapsed counter-rotative springs where each loop rests on top of the preceding loop.

Optionally, each of the lower leg module 13, the upper leg module 11, the pushrod 42 and the connection between each sub-axilla support and the corresponding hip joint 21, is adjustable in length by a length regulation device 60, 61, 62, 63, 64, or by a telescopic length regulation device 60, 61, 62, 63, 64, included therein.

Thanks to said length regulation device 60, 61, 62, 63, 64 the lower limb exoskeleton can be adapted to the height of each user in a simple manner, by adjusting the length of the lower leg module 13 and of the upper leg module 11, and also by adjusting the length of the pushrod 42 and the distance between the sub-axilla support and the hip joint.

Said length regulation device 60, 61, 62, 63, 64 may, for example, be formed by a telescopic configuration, e.g. with two mutually sliding portions which can be maintained in relative position by a retainer, such as a transverse pin, or with two threaded portions which produce extension or contraction by mutual rotation.

According to the embodiments shown in the Fig., the distance between the sub-axilla support 23 and the hip joint 21 is adjusted through a first length regulation device 60 comprising a screw threaded around the axially collapsed spring 27 constitutive of the flexible non-compressible connection between said elements, using the coils of the spring as threads, the screw acting as an adjustable stopper to regulate the insertion of the axially collapsed spring 27 in a housing in the vertical direction.

The length of the upper leg module 11 can be adjusted, in this embodiment, through a second length regulation device 61 comprising two mutually inserted parts connected through a pin, one of the two mutually inserted parts including multiple openings for the pin at different longitudinal positions.

The length of the pushrod 42 can be adjusted through a threaded telescopic element interposed between the lower end 42b and the rest of the pushrod 42.

The length of the lower leg module 13 can be adjusted by attaching the lower supporting foothold 15 at different positions along the longitude of the lower leg module 13, on different perforations distributed along the lower leg module 13.

According to one proposed embodiment, the kinematic linkage between the upper end 42a of the pushrod 42 comprises a curved guide 41, attached to a lower end of the upper leg module 11 adjacent to the knee joint 12, the curved guide 41 being elongated from a first end 41a to a second end 41b defining a trajectory from the first end 41a towards the second end 41b, where successive points of the curved guide 41 are increasingly distant from the knee joint 12, the upper end 42a of the pushrod 42 being slidably connected to said curved guide 42.

Successive points of the curved guide 41 from a first end 41a to a second end 41b preferably form a decreasingly acute angle in regards a straight line connecting each of said successive points with the knee joint 12.

According to the above, for example, when the limb assembly is in a maximal flexed position, the upper end 42a of the pushrod 42 is adjacent to the first end 41a of the curved guide 41 and defines an acute angle preferably comprised between 70° and 80°, and/or when the limb assembly is in a maximal extended position, the upper end 42a of the pushrod 42 is adjacent to the second end 41b of the curved guide 41 and defines an acute angle preferably comprised between 40° and 30°.

According to the above, the knee actuation mechanism comprises a curved guide 41 attached to the lower end of the upper leg module 11, being this curved guide 41 preferably coplanar with a vertical plane perpendicular to the transverse axis of the knee joint 12.

The knee actuation mechanism further comprises the pushrod 42, which can be a bar elongated in the vertical direction, typically parallel to the lower leg module 13 and longer than said lower leg module 13.

The pushrod 42 protrudes upwardly from the upper end of the lower leg module 13, above the knee joint 12, and downwardly below the lower supporting foothold 15.

An intermediate region of the pushrod 42 is connected to the lower leg module 13 in a slidably manner, allowing a linear guided movement of the pushrod 42 only in the direction of said linear guiding, which is vertical when the lower leg module 13 is in a vertical position.

According to the embodiment described above, an upper end 42a of the pushrod 42 is slidably connected to the curved guide 41, so that when the angle of the knee joint 12 changes, producing a relative rotation of the curved guide 41 in regards the lower leg module 13 and the pushrod 42 connected thereto, the upper end 42a of the pushrod 42 is forced to slide along the curved guide 41 pushing the pushrod 42 in the lineal direction (upwards or downwards), producing an increase or a decrease in the longitude of the lower end 42b of the pushrod 42 protruding downwardly.

When one limb assembly is partially flexed, the lower end 42b of the pushrod 42 protrudes downwardly so that, when the weight of the user rests on this leg, this lower end 42b enters in contact with the ground and is pushed upwards by said weight. The upward movement of the pushrod 42 produces an upward movement of its upper end 42a which, when interacting with the curved guide 41, produces the sliding between the upper end 42a and the curved guide 41 pushing the curved guide 41 to a new position compatible with this new position of the pushrod 42, and thus producing a rotation of the knee joint 12 towards the extended position.

To achieve this result, the curved guide 41 is gradually shifted away from the knee joint 12, so that successive straight lines connecting the knee joint 12 with successive points of the curved guide 41, from a first end 41a closer to the knee joint 12 towards a second end 41b away from the knee joint 12, are increasingly longer in longitude.

An upward movement of the pushrod 42 produces an increase in the longitude of the portion of the pushrod 42 protruding upwards from the knee joint 12 forcing the rotation of the curved guide 41 towards the second end 41b to accommodate such increase in longitude.

Also, each of said successive straight lines intersect with the curved guide 41 at one point defining one acute angle, said acute angle being increasingly smaller from the first end 41A towards the second end 41b.

This acute angle determines how the upward force produced by the pushrod 42 is distributed between the rotation of the knee joint 12 and the sliding of the pushrod 42 on the curved guide 41.

When the upper end 42a of the pushrod 42 is closer to the first end 41a of the curved guide 41, the acute angle is grater, preferably comprised between 70° and 80°, producing that most of the upward force of the pushrod 42 pushes the curved guide 41 upwards.

Contrary, when the upper end 42a of the pushrod 42 is closer to the second end 41b of the curved guide 41, the acute angle is smaller, preferably between 40° and to 50°, producing that only half of the upward force of the pushrod 42 pushes the curved guide 41 upwards.

The knee actuation mechanism 40 may further comprise a linear motor 43 with one end connected to the upper leg module 11, in a position adjacent to the second end 41b of the curved guide 41, and with an opposed end connected to the lower leg module 13, in a position adjacent to the knee joint 12.

The increase in length of the linear motor 43 produces the movement of the lower limb assembly 10 towards the extended position.

In this case, the knee actuation mechanism 40 may integrate a sensor configured to detect a variation in the inclination between the upper and lower leg modules 11, 13 or configured to detect a variation in the linear position of the pushrod 42, or configured to detect a pression on the second end 42b of the pushrod 42 and wherein the linear motor 43 is configured to be activated in response to a detection obtained through said sensor.

The limb assembly 10 may further comprise a hand-assist system 50 comprising a transmission bar 51, or a transmission bar 51 with an adjustable longitude, with a lower end attached trough articulation to the lower leg module 13 and with an upper end with a handle 52 slidably connected to the upper leg module 11 for a guided linear movement of the handle 52 along the upper leg module 11, further urging the lower limb assembly 10 towards the extended position with a downward force applied by the user with his/her hands on the handle 52.

According to one embodiment, the lower supporting foothold 15 may comprise a foot module connected to a lower end of the lower leg module 13 through an interposed articulated ankle joint 14, for example a ball joint.

The foot module can be, for example, a footwear or a stirrup attachable to a footwear.

1. A lower limb exoskeleton comprising:
a torso module including an adjustable abdominal binder and two lower limb assemblies connected to the torso module through a hip joint, each limb assembly comprising, connected in succession, an upper leg module, a knee joint, a lower leg module and a lower supporting foothold, intended to be supported on a floor for transferring vertical loads of the lower limb assembly, wherein the hip joint and the knee joint are articulated joints;
each limb assembly further comprises a knee actuation mechanism configured to modify the angle of the knee joint when actuated;
at least the upper leg module and the lower leg module including at least one body attachment configuration intended for attachment to an adjacent body part of a user;
wherein the knee actuation mechanism comprises a pushrod with an intermediate region slidably connected to the lower leg module for a guided linear movement of the pushrod along a linear displacement path, the pushrod including a lower end protruding downwardly below the lower supporting foothold when the pushrod is not in the uppermost position of the linear displacement path, and including an upper end connected to the upper leg module via a kinematic linkage configured to push the upper leg module into an extended position, in which both upper and lower leg modules are approximately parallel or aligned, when the pushrod is moved upwards by resting the lower end thereof against a ground under user's body weight;
wherein the kinematic linkage connecting the upper end of the pushrod with the upper leg module comprises a curved guide, attached to a lower end of the upper leg module adjacent to the knee joint, the curved guide being elongated from a first end to a second end defining a trajectory from the first end towards the second end, where successive points of the curved guide are increasingly distant from the knee joint, the upper end of the pushrod being slidably connected to the curved guide.

2. The lower limb exoskeleton according to claim 1 wherein the torso module comprises:
two sub-axilla supports, each extending upwards from one hip joint; or
two sub-axilla supports, each extending upwards from one hip joint and two shoulder straps; or
two sub-axilla supports, each extending upwards from one hip joint and a sub-gluteal support extending downwards from a back side of the adjustable abdominal binder; or
two sub-axilla supports, each extending upwards from one hip joint and two shoulder straps and a sub-gluteal support extending downwards from a back side of the adjustable abdominal binder.

3. The lower limb exoskeleton according to claim 1 wherein the adjustable abdominal binder further includes vertical reinforcement ribs.

4. The lower limb exoskeleton according to claim 1, wherein the torso module is devoid of inguinal straps connecting a back side and a front side of the adjustable abdominal binder.

5. The lower limb exoskeleton according to claim 1 wherein each sub-axilla support is connected to the hip joint located below through a non-compressible connection, or through a flexible non-compressible connection.

6. The lower limb exoskeleton according to claim 1 wherein each of the lower leg module, the upper leg module, the pushrod and the connection between each sub-axilla support and the corresponding hip joint, is adjustable in length by a length regulation device, or by a telescopic length regulation device, included therein.

7. (canceled)

8. The lower limb exoskeleton according to claim 1 wherein successive points of the curved guide from a first end to a second end form a decreasingly acute angle in regards a straight line connecting each of the successive points with the knee joint.

9. The lower limb exoskeleton according to claim 8 wherein when the limb assembly is in a maximal flexed position, the upper end of the pushrod is adjacent to the first end of the curved guide and defines an acute angle comprised between 70° and 80°, and/or when the limb assembly is in a maximal extended position, the upper end of the pushrod is adjacent to the second end of the curved guide and defines an acute angle comprised between 40° and 30°.

10. The lower limb exoskeleton according to claim 1 wherein the knee actuation mechanism further comprises a linear motor with one end connected to the upper leg module, in a position adjacent to the second end of the curved guide, and with an opposed end connected to the lower leg module, in a position adjacent to the knee joint.

11. The lower limb exoskeleton according to claim 10 wherein the knee actuation mechanism integrates a sensor configured to detect a variation in the inclination between the upper and lower leg modules or configured to detect a variation in the linear position of the pushrod, or configured to detect a pression on the second end of the pushrod and wherein the linear motor is configured to be activated in response to a detection obtained through the sensor.

12. The lower limb exoskeleton according to claim 1 wherein the limb assembly further comprises a hand-assist system comprising a transmission bar, or a transmission bar with an adjustable longitude, with a lower end attached trough articulation to the lower leg module and with an upper end with a handle slidably connected to the upper leg module for a guided linear movement of the handle along the upper leg module, further urging the lower limb assembly towards the extended position.

13. The lower limb exoskeleton according to claim 1 wherein the lower supporting foothold comprises foot module connected to a lower end of the lower leg module through an interposed articulated ankle joint.

14. The lower limb exoskeleton according to claim 13 wherein the foot module is a footwear or a stirrup attachable to a footwear.
